(19) United States
(12) Patent Application Publication
(10) Pub. No.: US 2015/0162599 A1
(43) Pub. Date: Jun. 11, 2015

(54) POSITIVE ELECTRODE FOR RECHARGEABLE LITHIUM BATTERY, PREPARING SAME, AND RECHARGEABLE LITHIUM BATTERY

(71) Applicant: SAMSUNG SDI CO., LTD., Yongin-si (KR)

(72) Inventors: Yuki Takei, Yokohama-shi (JP); Masatsugu Nakano, Yokohama-shi (JP); Keisuke Nomura, Yokohama-shi (JP)

(21) Appl. No.: 14/562,344

(22) Filed: Dec. 5, 2014

(30) Foreign Application Priority Data
Dec. 9, 2013 (JP) 2013-254242
Aug. 25, 2014 (KR) 10-2014-0110914

(51) Int. Cl. H01M 4/131; H01M 10/052; H01M 4/1391; H01M 4/04; H01M 2/16; H01M 4/36

(52) U.S. Cl. CPC H01M 4/131; H01M 2/1686; H01M 4/366; H01M 4/1391; H01M 4/0404; H01M 4/0471; H01M 10/052; H01M 2/1646

(57) ABSTRACT

Provided are a positive electrode for a rechargeable lithium battery that includes a current collector; and a lithium nickel composite oxide represented by the Chemical Formula 1 and a first coating layer positioned on the surface of the lithium nickel composite oxide and including at least one oxyacid, a rechargeable lithium battery including the same and a method of preparing the same.

LiₐNi_{b}Co_{c}M_{d}O₂ Chemical Formula 1

### CROSS-REFERENCE TO RELATED APPLICATIONS

Any and all priority claims identified in the Application Data Sheet, or any correction thereto, are hereby incorporated by reference under 37 CFR 1.57. For example, this application claims priority to and the benefit of Japanese Patent Application No. 2013-254242 filed in the Japanese Patent Office on Dec. 9, 2013, and Korean Patent Application No. 10-2014-0110914 filed in the Korean Intellectual Property Office on Aug. 25, 2014, the disclosures of which are incorporated in their entirety by reference.

### BACKGROUND

1. Field

This disclosure relates to a positive electrode for a rechargeable lithium battery, a method of preparing the same, and a rechargeable lithium battery.

2. Description of the Related Technology

Recently, a lithium nickel composite oxide including nickel has been suggested as a positive active material capable of achieving a high potential and high capacity in a rechargeable lithium ion battery.

However, when the rechargeable lithium ion battery using the lithium nickel composite oxide as a positive active material in a full-charge is stored at a high temperature, a large amount of gas is generated, and an internal pressure of the battery is increased.

For example, Japanese Patent Laid-open No. 2013-026199 discloses that lithium hydroxide (LiOH) remaining on the surface of the lithium nickel composite oxide reacts with carbon dioxide (CO₂) to generate lithium carbonate (Li₂CO₃), and the lithium carbonate (Li₂CO₃) generates gas at a high temperature.

In addition, Japanese Patent Laid-open No. 2013-026199 discloses a technology of decreasing the lithium compound that causes the gas generation by washing the lithium nickel composite oxide and thus, suppressing the gas generation.

However, the technology of Japanese Patent Laid-open No. 2013-026199 has a drawback of decreasing lithium (Li) in the lithium nickel composite oxide via the washing and thus, deteriorating initial discharge capacity of the rechargeable lithium ion battery.

In addition, since a large amount of nickel (Ni) is mixed into the Li sites of the lithium nickel composite oxide after the washing (i.e., cation mixing), power characteristics and charge and discharge cycle characteristics are also deteriorated.

### SUMMARY

Some embodiments provide a positive electrode for a rechargeable lithium ion battery being capable of suppressing gas generation without deteriorating battery characteristics, a rechargeable lithium ion battery including the same, and a method of preparing the same.

In one embodiment, a positive electrode for a rechargeable lithium ion battery includes a current collector, and a lithium nickel composite oxide represented by the following Chemical Formula 1 and a first coating layer positioned on the surface of the lithium nickel composite oxide and including at least one oxyacid ion represented by one of the following Chemical Formulae 2 to 6.

LiₐNi_{b}Co_{c}M_{d}O₂ Chemical Formula 1

[Xⁿ⁺Mo₁₂O₄₀]⁽⁸⁻ⁿ⁾⁻ Chemical Formula 2

[Xⁿ⁺W₁₂O₄₀]⁽⁸⁻ⁿ⁾⁻ Chemical Formula 3

[Xⁿ⁺V₁₂O₄₀]⁽⁸⁻ⁿ⁾⁻ Chemical Formula 4

[Mo₇O₂₄]⁶⁻ Chemical Formula 5

[VO₃]ₘ^{m-} Chemical Formula 6

In the Chemical Formulae 1 to 6,

M is selected from Al, Mn, Cr, Fe, V, Mg, Ti, Zr, Nb, Mo, W, Cu, Zn, Ga, In, Sn, La, Ce, or a combination thereof, 0.20≦a≦1.20, 0.80≦b<1.00, 0<c≦0.20, 0≦d≦0.10, and a+b+c=1,

X is P, or Si, n is a natural number of 7 or less, and m is a natural number.

A coating coverage ratio of the first coating layer may be greater than or equal to about 1% and less than or equal to about 20%.

The positive electrode may further include a second coating layer including an inorganic filler at least one side thereof.

The second coating layer may include at least one of Mg(OH)₂ and Al₂O₃.

Another embodiment provides a method of preparing a positive electrode for a rechargeable lithium battery that includes preparing a lithium nickel composite oxide represented by the following Chemical Formula 1, applying a mechanical shear force to the surface of the lithium nickel composite oxide particle to form a first coating layer including at least one oxyacid ion represented by one of the following Chemical Formulae 2 to 6, heating the lithium nickel composite oxide particle on which the first coating layer is formed to prepare a positive active material, and coating the positive active material on a current collector.

LiₐNi_{b}Co_{c}M_{d}O₂ Chemical Formula 1

[Xⁿ⁺Mo₁₂O₄₀]⁽⁸⁻ⁿ⁾⁻ Chemical Formula 2

[Xⁿ⁺W₁₂O₄₀]⁽⁸⁻ⁿ⁾⁻ Chemical Formula 3

[Xⁿ⁺V₁₂O₄₀]⁽⁸⁻ⁿ⁾⁻ Chemical Formula 4

[Mo₇O₂₄]⁶⁻ Chemical Formula 5

[VO₃]ₘ^{m-} Chemical Formula 6

In the Chemical Formulae 1 to 6,

M is selected from Al, Mn, Cr, Fe, V, Mg, Ti, Zr, Nb, Mo, W, Cu, Zn, Ga, In, Sn, La, Ce, or a combination thereof, 0.20≦a≦1.20, 0.80≦b<1.00, 0<c≦0.20, 0≦d≦0.10, and a+b+c=1,

X is P, or Si, n is a natural number of 7 or less, and m is a natural number.

The step of heating the lithium nickel composite oxide particle on which the first coating layer may be formed can be performed under an oxidation atmosphere.

The step of coating the positive active material on a current collector may be performed at a dew point temperature of about −40° C.

In yet another embodiment, a rechargeable lithium battery includes the positive electrode, a negative electrode, an electrolyte, and a separator interposed between the positive electrode and the negative electrode.

The separator may include a coating layer including an inorganic filler on at least one side thereof.

The inorganic filler may include Mg(OH)₂ or Al₂O₃.

The negative electrode may include graphite.

According to the present disclosure, gas generation may be suppressed without deteriorating battery characteristics of a rechargeable lithium ion battery.

### BRIEF DESCRIPTION OF THE DRAWINGS

FIG. 1 is a schematic view showing a structure of a rechargeable lithium ion battery according to an exemplary embodiment.

FIG. 2 is a graph showing gas generation amounts of Example 1, Comparative Example 1 and 2 and Reference Example.

FIG. 3 is a graph showing discharge capacity at each C-rate of Example 13, Comparative Example 3 and Reference Example.

FIG. 4 shows an EDX phase for Mo of the lithium nickel composite oxide particle according to Example 1.

FIG. 5 shows an EDX phase for Ni of the lithium nickel composite oxide particle according to Example 1.

FIG. 6 shows an EDX phase for W of the lithium nickel composite oxide particle according to Example 2.

FIG. 7 shows an EDX phase for Ni of the lithium nickel composite oxide particle according to Example 2.

### DETAILED DESCRIPTION OF CERTAIN INVENTIVE EMBODIMENTS

Exemplary embodiments will hereinafter be described in detail. However, these embodiments are only exemplary, and the present disclosure is not limited thereto.

First, a rechargeable lithium ion battery according to one embodiment is described.

A rechargeable lithium ion battery according to one embodiment includes a lithium nickel composite oxide.

The rechargeable lithium ion battery using the lithium nickel composite oxide as a positive active material may achieve a high potential and high discharge capacity.

On the other hand, when the rechargeable lithium ion battery using the lithium nickel composite oxide as a positive active material in a full-charge is stored at a high temperature, a large amount of gas is generated, and internal pressure of the battery is increased.

In particular, when a lithium nickel composite oxide represented by the following Chemical Formula 1 and having a high nickel (Ni) ratio is used as a positive active material, energy density of the rechargeable lithium ion battery is increased, and thus, increasing the possibility of gas generation and a rise in the internal pressure.

LiₐNi_{b}Co_{c}M_{d}O₂ Chemical Formula 1

In the above Chemical Formula 1,

M is selected from Al, Mn, Cr, Fe, V, Mg, Ti, Zr, Nb, Mo, W, Cu, Zn, Ga, In, Sn, La, Ce, or a combination thereof, 0.20≦a≦1.20, 0.80≦b<1.00, 0<c≦0.20, 0≦d≦0.10, and a+b+c=1.

Herein, JP 2013-026199 suggests a method of removing an alkali component such as LiOH and Li₂CO₃ remaining on the surface of the lithium nickel composite oxide, for example, by washing the lithium nickel composite oxide to solve the problem.

However, the method has a drawback of deteriorating initial discharge capacity of the rechargeable lithium ion battery since Li is decreased by washing the lithium nickel composite oxide.

A rechargeable lithium ion battery according to one embodiment includes a first coating layer positioned on the surface of the lithium nickel composite oxide and including at least one oxyacid ion represented by one of the following Chemical Formulae 2 to 6, and simultaneously, a second coating layer including an inorganic filler on at least one of a positive electrode or a separator.

[Xⁿ⁺Mo₁₂O₄₀]⁽⁸⁻ⁿ⁾⁻ Chemical Formula 2

[Xⁿ⁺W₁₂O₄₀]⁽⁸⁻ⁿ⁾⁻ Chemical Formula 3

[Xⁿ⁺V₁₂O₄₀]⁽⁸⁻ⁿ⁾⁻ Chemical Formula 4

[Mo₇O₂₄]⁶⁻ Chemical Formula 5

[VO₃]ₘ^{m-} Chemical Formula 6

In the Chemical Formulae 2 to 6,

X is P, or Si, n is a natural number of 7 or less, and m is a natural number.

Herein, since the acid and compound including oxyacid ions work as a strong oxidizing agent, LiOH and Li₂CO₃ remaining on the surface of a lithium nickel composite oxide particle having a first coating layer including the oxyacid ions on the surface are oxidized and generate CO₂ when the lithium nickel composite oxide particles are heat-treated after forming the first coating layer.

Therefore, since the CO₂ generated inside the battery may be released in advance, when the rechargeable lithium ion battery is stored at a high temperature, the gas generation may be suppressed.

In addition, due to an oxidation of the acid or compound including the oxyacid, the alkali component such as LiOH, Li₂CO₃ and the like remaining on the surface of the lithium nickel composite oxide particle is removed in the rechargeable lithium ion battery according to one embodiment, and the decrease in Li is reduced.

Accordingly, the rechargeable lithium ion battery of one embodiment may suppress degradation of initial discharge capacity.

In addition, the rechargeable lithium ion battery according to one embodiment includes a second coating layer including an inorganic filler on at least one of a positive electrode or a separator.

In general, when a rechargeable lithium ion battery in a full charge state is stored at a high temperature, an electrolyte may be oxidized and decomposed on the surface of the positive electrode and thus, generate a gas.

However, since a rechargeable lithium ion battery according to one embodiment is prevented from a direct contact of a positive electrode with a separator by a second coating layer including an inorganic filler, an electrolyte may be suppressed from decomposition at the interface of the positive electrode and the separator in a high oxidation state.

Accordingly, when the rechargeable lithium ion battery according to one embodiment in a full-charge state is stored at a high temperature, gas generation may be suppressed.

In particular, the rechargeable lithium ion battery according to one embodiment includes the first coating layer including oxyacid ions as an oxidizing agent on the surface of the lithium nickel composite oxide particle, and thus, the electrolyte may be easily decomposed on the surface of the positive electrode.

Hence, the second coating layer including an inorganic filler is formed on the surface of the first coating layer or on a separator and may suppress decomposition of the electrolyte.

Specifically, the second coating layer may include Mg(OH)₂ or Al₂O₃.

As illustrated above, the rechargeable lithium ion battery according to one embodiment may suppress gas generation and simultaneously maintain initial discharge capacity, output characteristics and charge and discharge cycle characteristics when the battery in a full-charge state is stored at a high temperature.

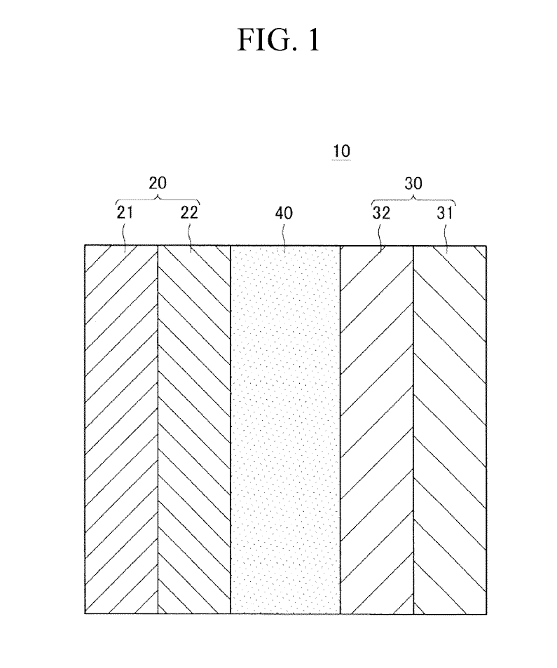

Hereinafter, referring to FIG. 1, a specific structure of the rechargeable lithium ion battery 10 according to one embodiment is described.

FIG. 1 is a schematic view showing a structure of a rechargeable lithium ion battery according to an exemplary embodiment.

As shown in FIG. 1, a rechargeable lithium ion battery 10 is a rechargeable lithium ion battery including a lithium nickel composite oxide as a positive active material, a positive electrode 20, a negative electrode 30, and a separator layer 40.

The rechargeable lithium ion battery 10 is not particularly limited in a shape.

For example, the rechargeable lithium ion battery 10 may have any shape such as a cylinder, a prism, a laminate type, a button type and the like.

The positive electrode 20 includes a current collector 21 and a positive active material layer 22.

The current collector 21 may consist of, for example aluminum (Al).

The positive active material layer 22 includes at least positive active material and a conductive material, and further includes a binder.

The positive active material may include a lithium nickel composite oxide having a high Ni ratio.

The lithium nickel composite oxide having a high Ni ratio according to one embodiment may have a composition, for example, represented by the following Chemical Formula 1.

On the other hand, the rechargeable lithium ion battery according to one embodiment may further include a plurality of active material as a positive active material besides the lithium nickel composite oxide having a high Ni ratio.

LiₐNi_{b}Co_{c}M_{d}O₂ Chemical Formula 1

In the above Chemical Formula 1,

M is selected from Al, Mn, Cr, Fe, V, Mg, Ti, Zr, Nb, Mo, W, Cu, Zn, Ga, In, Sn, La, Ce, or a combination thereof, 0.20≦a≦1.20, 0.80≦b<1.00, 0<c≦0.20, 0≦d≦0.10, and a+b+c=1.

A rechargeable lithium ion battery according to one embodiment may include a second coating layer including an oxyacid ion represented by one of the following Chemical Formulae 2 to 6 on the particle surface of the lithium nickel composite oxide having a high Ni ratio and having the composition.

[Xⁿ⁺Mo₁₂O₄₀]⁽⁸⁻ⁿ⁾⁻ Chemical Formula 2

[Xⁿ⁺W₁₂O₄₀]⁽⁸⁻ⁿ⁾⁻ Chemical Formula 3

[Xⁿ⁺V₁₂O₄₀]⁽⁸⁻ⁿ⁾⁻ Chemical Formula 4

[Mo₇O₂₄]⁶⁻ Chemical Formula 5

[VO₃]ₘ^{m-} Chemical Formula 6

In the Chemical Formulae 2 to 6,

X is P, or Si, n is a natural number of 7 or less, and m is a natural number.

The oxyacid ion represented by one of the Chemical Formulae 2 to 6 may be specifically a polyoxyacid (polyoxometalate) ion that is formed by condensation of the oxyacid ion.

The polyoxyacid ion may be specifically an isopolyacid ion consisting of one kind of a transition metal ion and a hetero polyacid ion including a hetero atom (phosphorus (P), silicon (Si) and the like) in a polyacid backbone.

In addition, compounds including the oxyacid ion represented by one of the Chemical Formulae 2 to 6 may be, for example, ammonium molybdate, silicotungstic acid, phosphomolybdic acid, ammonium phosphotungstate, ammonium phosphomolybdate, ammonium metavanadate, and the like.

The oxyacid ion represented by one of the Chemical Formulae 2 to 6 is bonded with a plurality of oxygen atom and thus an oxidation number of the center element is high and may act as a strong oxidizing agent.

Accordingly, an alkali component such as LiOH, Li₂CO₃ and the like remaining on the surface of a lithium nickel composite oxide particle having the first coating layer including the oxyacid ion represented by the Chemical Formulae 2 to 6 may be oxidized and release gas such as CO₂ and the like when the lithium nickel composite oxide particle is heat-treated.

Accordingly, since the CO₂ gas generated is released in advance out of the battery, when the rechargeable lithium ion battery according to one embodiment is stored at a high temperature, the battery may be suppressed from gas generation.

Herein, a coating coverage ratio of the first coating layer on the lithium nickel composite oxide particle may be measured, for example, through X-ray photoelectron spectroscopy (XPS) and the like.

Specifically, the XPS about the surface of the lithium nickel composite oxide particle coated with the first coating layer is measured, and a spectrum about binding energy is obtained therefrom.

Next, a background is subtracted from the obtained spectrum, and the area of each peak is calculated.

In addition, which peak corresponds to which particular element is determined based on the binding energy of each element.

For example, the binding energy of each element may use a value described in the following Table 1.

TABLE 1

| Element | Binding energy (eV) |
|---|---|
| Ni | 850-885 |
| Co | 775-800 |
| Al | 119 |
| Mo | 230-240 |
| W | 32-40 |

In addition, the peak area of each element is revised by photoelectron release efficiency (a sensitivity factor) of each element, and the number of each atom is obtained therefrom.

Subsequently, the coating coverage ratio is obtained by dividing the number of atoms of an element included in the oxyacid ion (however, exclude oxygen and a hetero element) with the sum of the number of atoms of an element included in the lithium nickel composite oxide (however, exclude lithium and oxygen) and the number of atoms of an element included in the oxyacid ion (however, exclude oxygen and a hetero element).

For example, when the oxyacid ion included in the first coating layer is [Mo₇O₂₄]⁶⁻, and the lithium nickel composite oxide particle has a composition of LiNi_{0.8}Co_{0.15}Al_{0.05}O₂, the coating coverage ratio may be calculated by the number of an atoms of Mo with the sum of the number of atoms of Ni, Co, Al and Mo.

On the other hand, the content of the lithium nickel composite oxide having a high Ni ratio in the active material layer is not particularly limited, and may be any content that may be applicable to a positive active material layer of a conventional rechargeable lithium ion battery.

The conductive agent may be, for example carbon black such as ketjen black, acetylene black, and the like, natural graphite, artificial graphite, and the like.

However, the conductive agent may be any one in order to improve conductivity of a positive electrode without limitation.

The content of the conductive material is not particularly limited, and may be any content that may be applicable in a positive active material layer of a rechargeable lithium ion battery.

The binder may be, for example polyvinylidene fluoride, an ethylene-propylene-diene terpolymer, a styrene-butadiene rubber, an acrylonitrile-butadiene rubber, fluororubber, polyvinyl acetate, polymethyl methacrylate, polyethylene, nitrocellulose, and the like.

But the binder may not be particularly limited, if it binds the positive active material and the conductive material on the current collector 21.

The content of the binder is not particularly limited, and may be any content that may be applicable in a positive active material layer of a rechargeable lithium ion battery.

The positive active material layer 22 is formed by dispersing a positive active material, a conductive agent and a binder into an appropriate organic solvent (for example, N-methyl-2-pyrrolidone) to prepare slurry, coating the slurry on a current collector 21, and then, drying and compressing it.

The negative electrode 30 includes a current collector 31 and a negative active material layer 32. The current collector 31 may include, for example, copper (Cu), nickel (Ni), and the like.

The negative active material layer 32 may be any negative active material layer of a rechargeable lithium ion battery.

For example, the negative active material layer 32 includes a negative active material and may further include a binder.

The negative active material may be, for example, a graphite active material (artificial graphite, natural graphite, a mixture of artificial graphite and natural graphite, natural graphite coated with artificial graphite, and the like), a mixture of a particulate of silicon (Si) or tin (Sn) or oxides thereof and a graphite active material, a silicon or tin particulate, an alloy including silicon or tin as a basic material, and titanium-based oxide compound such as Li₄Ti₅O₁₂ and the like.

The silicon oxide may be represented by SiOₓ (0<x≦2).

The negative active material may be, for example metal lithium and the like besides the above materials.

In one embodiment, the negative active material may be preferably graphite.

Through such a structure, while maintaining battery characteristics, gas generation may be suppressed when being stored in a full-charge state at a high temperature as evidenced in the post-described Examples.

The binder may be the same as the binder of the positive active material layer 22.

On the other hand, a weight ratio of the negative active material and the binder is not particularly limited, and may be a weight ratio of a conventional rechargeable lithium ion battery.

The separator layer 40 includes a separator and an electrolyte.

A separator according to one embodiment includes a second coating layer including an inorganic filler.

Specifically, the second coating layer may include at least one of Mg(OH)₂ or Al₂O₃ as an inorganic filler.

Through such a structure, the coating layer including the inorganic filler may not have direct contact between the positive electrode and the separator, oxidation and decomposition of an electrolyte on the surface of the positive electrode during storage at a high temperature may be prevented, and generation of decomposed products of electrolyte and gas may be suppressed.

Herein, the second coating layer including an inorganic filler may be formed on both sides of the separator or one side of the separator toward the positive electrode.

The coating layer including the inorganic filler is formed on the side toward the positive electrode, direct contact between the positive electrode and the electrolyte solution may be inhibited.

In addition, the present disclosure is not limited to these embodiments.

For example, the second coating layer including an inorganic filler may be formed on the positive electrode as well as on the separator.

In this case, the second coating layer including an inorganic filler is formed on at least one side of the positive electrode, and thus direct contact between the positive electrode and the separator may be prevented.

On the other hand, the second coating layer including an inorganic filler may be formed on both the positive electrode and the separator.

On the other hand, the structure of the separator except the coating layer one embodiment is not particularly limited.

A substrate to be coated with the coating layer for the separator according to one embodiment may be any substrate used as a separator of a conventional rechargeable lithium ion battery.

For example, the substrate may be a porous film or a non-woven fabric having excellent high rate discharge performance that may be used singularly or with other materials.

The materials constituting the substrate may be, for example, a polyolefin-based resin such as polyethylene, polypropylene, and the like, a polyester-based resin such as polyethylene terephthalate, polybutylene terephthalate, and the like, a polyvinylidene difluoride, vinylidene fluoride-hexafluoro propylene copolymer, a vinylidene fluoride-perfluoro vinylether copolymer, a vinylidene fluoride-tetrafluoroethylene copolymer, a vinylidene fluoride-trifluoro ethylene copolymer, a vinylidene fluoride-fluoro ethylene copolymer, a vinylidene fluoride-hexafluoro acetone copolymer, a vinylidene fluoride-ethylene copolymer, a vinylidene fluoride-propylene copolymer, a vinylidene fluoride-trifluoro propylene copolymer, a vinylidene fluoride-tetrafluoroethylene-hexafluoro propylene copolymer, a vinylidene fluoride-ethylene-tetrafluoroethylene copolymer, and the like.

The porosity of the substrate is not particularly limited, and may be any porosity which a separator of a conventional rechargeable lithium ion battery has.

The electrolyte may be the same non-aqueous electrolyte as that being applicable in a conventional rechargeable lithium battery without limitation.

Herein, the electrolyte has a composition including an electrolytic salt in a non-aqueous solvent.

The non-aqueous solvent may be, for example, cyclic carbonate esters such as propylene carbonate, ethylene carbonate, butylene carbonate, chloroethylene carbonate, vinylene carbonate, and the like; cyclic esters such as γ-butyrolactone, γ-valero lactone and the like; linear carbonates such as dimethyl carbonate, diethylcarbonate, ethylmethyl carbonate, and the like; linear esters such as methyl formate, methyl acetate, methyl butyrate, and the like; ethers such as tetrahydrofuran or a derivative thereof; ethers such as 1,3-dioxane, 1,4-dioxane, 1,2-dimethoxy ethane, 1,4-dibutoxyethane, methyl diglyme and the like; nitriles such as acetonitrile, benzonitrile, and the like; dioxolane or a derivative thereof; ethylene sulfide, sulfolane, sultone or a derivative thereof which may be used singularly or as a mixture of two or more, without limitation.

The electrolytic salt may be, for example, an inorganic ion salt including lithium (Li), sodium (Na) or potassium (K) such as LiClO₄, LiBF₄, LiAsF₆, LiPF₆, LiSCN, LiBr, LiI, Li₂SO₄, Li₂B₁₀Cl₁₀, NaClO₄, NaI, NaSCN, NaBr, KClO₄, KSCN and the like, an organic ion salt such as LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅O₂)₃, (CH₃)₄NBF₄, (CH₃)₄NBr, (C₂H₅)₄NClO₄, (C₂H₅)₄NI, (C₃H₇)₄NBr, (n-C₄H₉)₄NClO₄, (n-C₄H₉)₄NI, (C₂H₅)₄N-maleate, (C₂H₅)₄N-benzoate, (C₂H₅)₄N-phtalate, lithium stearyl sulfate, lithium octyl sulfate, lithium dodecylbenzene sulphonate, and the like.

The ionic compounds may be used singularly or as a mixture of two or more.

The concentration of the electrolytic salt may be the same as that of a non-aqueous electrolyte used in a conventional rechargeable lithium battery, and is not particularly limited.

In the present disclosure, an electrolyte solution including an appropriate lithium compound (electrolytic salt) at a concentration of about 0.5 mol/L to about 2.0 mol/L may be used.

Subsequently, a method of preparing the lithium nickel composite oxide having a high Ni ratio according to one embodiment is illustrated.

The method of preparing the lithium nickel composite oxide having a high Ni ratio has no particular limit but may include for example, co-precipitation.

Hereinafter, the co-precipitation method of preparing the lithium nickel composite oxide is illustrated.

First of all, nickel sulfate hexahydrate (NiSO₄.6H₂O), cobalt sulfate pentahydrate (CoSO₄.5H₂O) and a compound including a metal element M are dissolved in ion exchange water, preparing a mixed aqueous solution.

Herein, the total weight of the nickel sulfate hexahydrate, the cobalt sulfate pentahydrate and the compound including a metal element M may be for example about 20 wt % based on the total weight of the mixed aqueous solution.

In addition, the nickel sulfate hexahydrate, the cobalt sulfate pentahydrate and the compound including a metal element M may be mixed in a desired mole ratio among Ni, Co and M.

On the other hand, the mole ratio of each element is determined depending on the composition of the lithium nickel composite oxide, and, for example, LiNi_{0.8}Co_{0.15}Al_{0.05}O₂ may be prepared in a mole ratio of Ni:Co:Al=80:15:5.

The metal element, M may be one or more kinds of elements selected form, for example, Al, Mn, Cr, Fe, V, Mg, Ti, Zr, Nb, Mo, W, Cu, Zn, Ga, In, Sn, La, Ce.

In addition, the compound including a metal element M may be, for example, various salts of the metal element M such as a sulfate, a nitrate and the like, an oxide and a hydroxide of the metal element M and the like.

The ion exchange water may be a product obtained by maintaining ion exchange water at 50° C. and bubbling the resultant by inert gas such as nitrogen and the like to remove oxygen dissolved therein.

Then, a saturated NaOH aqueous solution is added to the mixed aqueous solution in a dropwise fashion in order to have a pH of 8 to 12, and agitated, while the mixed aqueous solution is maintained at 50° C.

The addition speed has no particular limit, but if added too rapidly, a uniform precursor (a co-precipitation hydroxide salt) may not be obtained.

For example, the addition speed in a dropwise fashion may be about 3 ml/min.

This treatment is performed, for example, at a predetermined speed for predetermined time.

Accordingly, hydroxide salt of each metal element is co-precipitated.

Subsequently, the co-precipitated hydroxide salt is taken from the reaction layer aqueous solution through solid-liquid separation (for example, an absorption filter) and washed with ion exchange water.

In addition, the co-precipitation hydroxide salt is vacuum-dried.

The vacuum drying is performed, for example, at about 100° C. for about 10 hours.

Subsequently, the co-precipitated hydroxide salt after the drying is ground with a mortar and a pestle for a couple of minutes, obtaining a dry powder.

The dry powder is mixed with lithium hydroxide (LiOH), obtaining a mixed powder.

Herein, a mole ratio between Li and Ni+Mn+M (=Me) is determined depending on the composition of the lithium nickel composite oxide.

For example, LiNi_{0.8}Co_{0.15}Al_{0.05}O₂ may be prepared in a mole ratio of Li:Me=1.0:1.0.

In addition, this mixed powder is fired under an oxidation atmosphere for predetermined time at a predetermined temperature.

On the other hand, since the Ni in the lithium nickel composite oxide is easily reduced, the firing may be performed under an oxidation atmosphere.

The oxidation atmosphere may be, for example, an oxygen atmosphere.

In addition, the firing temperature may be for example, about 700° C. to about 800° C., and the firing time may be, for example, about 10 hours.

Furthermore, the compound including oxyacid ions and represented by one of the Chemical Formulae 2 to 6 is added to 100 parts by weight of the lithium nickel composite oxide and thus, is coated on the surface of lithium nickel composite oxide particles and forms a first coating layer.

A method of coating the compound including oxyacid ions on the surface of the lithium nickel composite oxide particle may specifically use a mechanical shear force.

For example, the coating of the compound including oxyacid ions on the surface of the lithium nickel composite oxide by using the mechanical shear force may be performed by using an a powder treatment device (NOB MINI, Hosokawa Micron Corp., Tokyo, Japan) at about 3000 rpm for about 15 minutes.

Herein, the compound including oxyacid ions may be oxyacid or a salt with ammonium ions and the like.

On the other hand, the method of coating the compound including oxyacid ions on the surface of the lithium nickel composite oxide particles is not limited thereto but may include just mixing of the compound including oxyacid ions with the lithium nickel composite oxide particles.

However, the compound including oxyacid ions may be uniformly on the surface of the lithium nickel composite oxide particle and form a uniform coating layer by using the mechanical shear force.

In addition, the compound including oxyacid ions may be used in any amount but in an amount of greater than or equal to about 0.25 parts by weight and less than or equal to about 2 parts by weight based on 100 parts by weight of the lithium nickel composite oxide.

When the compound including oxyacid ions is used within the range, the first coating layer including the oxyacid ions may be formed in a coating coverage ratio of greater than or equal to about 1% and less than or equal to about 2% on the surface of the lithium nickel composite oxide.

On the other hand, when the coating coverage ratio is within the range, the compound including oxyacid ions may sufficiently oxidize LiOH, Li₂CO₃, and the like remaining on the surface of the lithium nickel composite oxide particles but simultaneously, not hinder in and out of lithium ions.

Subsequently, the lithium nickel composite oxide particles coated with the first coating layer including the compound including oxyacid ions may be heat-treated under an oxidation atmosphere for predetermined time at a predetermined temperature.

However, this heat treatment decomposes the compound including oxyacid ions included in the coating layer of the lithium nickel composite oxide particles and thus, oxidizes an alkali component such as LiOH, Li₂CO₃ and the like on the surface of the lithium nickel composite oxide particles and releases CO₂ gas. Then, the obtained lithium nickel composite oxide particles are dried.

On the other hand, since Ni in the lithium nickel composite oxide is easily reduced, the heat treatment may be performed under an oxidation atmosphere. The oxidation atmosphere may be, for example, an oxygen atmosphere.

In addition, the firing temperature is set at a temperature where the surface of the lithium nickel composite oxide is sufficiently oxidized depending on a melting point of the compound including oxyacid ions.

On the other hand, when the firing temperature is too high, the crystal structure of the lithium nickel composite oxide is destabilized (a rock salt) and deteriorates the discharge capacity, and thus, the temperature may not be too far above the melting point of the compound including oxyacid ions.

Specifically, the coated compound including oxyacid ions may be about 100° C. higher than the melting point of the compound.

For example, when the coated compound including oxyacid ions is (NH₄)₆Mo₇O₂₄ (a melting point of about 190° C.), the firing temperature may be about 300° C. In addition, the firing time may be, for example, about 4 hours.

According to the above method, a lithium nickel composite oxide particles having a coating layer including oxyacid ions represented by any one of Chemical Formulas 2 to 6 according to one embodiment may be manufactured.

Then, a method of preparing a rechargeable lithium ion battery 10 is described.

A method of preparing the rechargeable lithium ion battery 10 according to one embodiment of the present invention is as follows.

The positive electrode 20 is prepared as follows.

First, a positive active material, a conductive agent and a binder are mixed in a desired ratio, and the mixture is dispersed into an organic solvent (for example, N-methyl-2-pyrrolidone), forming slurry.

Then, the slurry is formed (for example, coated) on a current collector 21 and then, dried to form a positive active material layer 22.

On the other hand, the coating may not be particularly limited but performed by using, for example, a knife coater, a gravure coater, and the like.

Each following coating process is performed in the same method.

In addition, the positive active material layer 22 is compressed to have a desired thickness by using a compressor.

In this way, the positive electrode 20 is prepared.

Herein, the positive active material layer 22 has no particularly-limited thickness but may have any thickness that a positive active material layer for a rechargeable lithium ion battery has.

On the other hand, the positive active material is coated on the current collector under a dry environment at a dew point temperature of −40° C. or less.

When moisture is present on the positive active material, LiOH and Li₂CO₃ on the surface of the positive active material during storage at a high temperature may react with the moisture and generate gas.

Thereby, the step of coating a positive active material on a current collector may be performed under dry environment with low content of moisture at a dew point temperature of −40° C. or less.

The negative electrode 30 is prepared in the same method as used for the positive electrode 20.

First, a negative active material and a binder are mixed in a desired ratio, and the mixture is dispersed into an organic solvent (for example, N-methyl-2-pyrrolidone), forming slurry.

Then, the slurry is formed on a current collector 31 (for example, coated) and dried, forming a negative active material layer 32.

In addition, the negative active material layer 32 is compressed to have a desired thickness by using a compressor.

In this way, the negative electrode 30 is prepared.

Herein, the negative active material layer 32 has no particularly limited thickness but may have any thickness that a negative active material layer for a rechargeable lithium ion battery has.

In addition, when a metal lithium is used as the negative active material layer 32, the metal lithium foil may be overlapped with the current collector 31.

Then, the inorganic filler and polyvinylidene fluoride are mixed in a weight ratio of 70:30 and then coated on both sides of the separator.

Subsequently, the separator 40 is interposed between the positive electrode 20 and the negative electrode 30, preparing an electrode structure.

In addition, the electrode structure is processed to have a desired shape (for example, a cylinder, a prism, a laminate type, a button type and the like) and inserted into a container having the same shape.

An electrolyte having desirable composition is injected into the case, and impregnates into pores of the separator. Accordingly, a rechargeable lithium ion battery 10 is prepared.

Hereinafter, the embodiments are illustrated in more detail with reference to examples. However, these examples are exemplary, and the present disclosure is not limited thereto. Furthermore, what is not described in this disclosure may be sufficiently understood by those who have knowledge in this field and will not be illustrated here.

### Example 1

Nickel sulfate hexahydrate (NiSO₄.6H₂O), cobalt sulfate pentahydrate (CoSO₄.5H₂O) and aluminum nitrate (Al(NO₃)₃) were dissolved in ion exchange water, preparing a mixed aqueous solution.

Herein, the total weight of the nickel sulfate hexahydrate, the cobalt sulfate pentahydrate and the aluminum nitrate was 20 wt % based on the total weights of the mixed aqueous solution.

In addition, the nickel sulfate hexahydrate, the cobalt sulfate pentahydrate and the aluminum nitrate were mixed in a mole ratio of Ni:Co:Al=80:15:5 in each Example.

The ion exchange water was the product obtained by maintaining 500 ml of the ion exchange at 50° C. and by bubbling the resultant by nitrogen gas to remove oxygen dissolved therein.

Then, a saturated NaOH aqueous solution was added thereto in a dropwise fashion at a speed of 3 ml/min in order to have a pH of 11.5, and agitated, while the mixed solution was maintained at 50° C.

Herein, the agitation speed was 4 m/s to 5 m/s, and the agitation time was 10 hours. Accordingly, hydroxide salt of each metal element was co-precipitated.

The co-precipitated hydroxide salt was continuously taken from the reaction layer aqueous solution by using an absorption filter and washed with ion exchange water. Then, the co-precipitated hydroxide salt was vacuum-dried.

The vacuum drying was performed at 100° C. for 10 hours.

Then, the co-precipitated hydroxide salt after the drying was ground with a mortar and a pestle, obtaining dry powder.

The dry powder was mixed with lithium hydroxide (LiOH), obtaining mixed powder.

Herein, Li and Me (=Ni+Co+Al) had a mole ratio of 1.0:1.0.

In addition, this mixed powder was fired under an oxygen atmosphere for 10 hours at 700° C. to 800° C.

Furthermore, 1 part by weight of ammonium molybdate ((NH₄)₆MO₇O₂₄) was added to 100 parts by weight of the lithium nickel composite oxide after the firing, treated with a powder treatment device (NOB MINI, Hosokawa Micron Corp., Tokyo, Japan) at 3000 rpm for 15 minutes to coat the ammonium molybdate on the surface of lithium nickel composite oxide particles and form a first coating layer.

Subsequently, the lithium nickel composite oxide particles after forming the first coating layer were heat-treated at 300° C. under an oxygen atmosphere for 4 hours.

Then, the lithium nickel composite oxide particles were dried.

Herein, the average secondary particle diameter (D50) of the lithium nickel composite oxide was measured with a laser diffraction scattering particle distribution system (Microtrac MT3000, NIKKISO CO. LTD., Tokyo, Japan) and defined as an average particle diameter.

The average secondary particle diameter (D50) indicates a particle diameter of which cumulative value is 50% in a particle diameter distribution when the secondary particles of the lithium nickel composite oxide are regarded as a sphere.

On the other hand, the lithium nickel composite oxide of Example 1 had an average particle diameter of 7 μm.

Subsequently, the lithium nickel composite oxide was mixed with acetylene black and polyvinylidene fluoride in a weight ratio of 95:2:3.

This mixture was dispersed into N-methyl-2-pyrrolidone, forming slurry.

The slurry was coated on an aluminum foil as a current collector at a dew point temperature of less than or equal to −40° C. under a dry environment and dried to form a positive active material layer, manufacturing a positive electrode.

In addition, a negative electrode was manufactured by using graphite.

A separator was obtained by coating both sides of a porous polyethylene film (12 μm thick) with a mixture of Mg(OH)₂ and PVdF (polyvinylidene fluoride) in a weight ratio of 70:30.

The coating layer was 2 μm thick.

This separator was interposed between the positive and negative electrodes, manufacturing an electrode structure.

In addition, the electrode structure was processed to have a shape capable of being housed in a pouch full cell and then, inserted in to the pouch full cell.

On the other hand, an electrolyte solution was prepared by mixing ethylene carbonate and dimethyl carbonate in a volume ratio of 3:7 and dissolving lithium hexafluoro phosphate (LiPF₆) in a concentration of 1.3 mol/L in the non-aqueous solvent.

The electrolyte solution was injected into the pouch full cell to impregnate the separator with the electrolyte solution.

In this way, the rechargeable lithium ion battery cell according to Example 1 was manufactured.

### Examples 2 to 6 and Comparative Examples 1 and 2

Rechargeable lithium ion battery cells according to Examples 2 to 6 and Comparative Examples 1 and 2 were manufactured according to the same method as Example 1, with the following additions and exceptions.

Herein, Examples 2 to 6 respectively used a different compound including oxyacid ions from that of Example 1 to coat the lithium nickel composite oxide.

The coated compounds including oxyacid ions are provided in Table 3.

In addition, Comparative Example 1 included no coating layer formed by coating the lithium nickel composite oxide with the compound including oxyacid ions compared with Example 1.

Furthermore, Comparative Example 2 formed no coating layer including an inorganic filler on the separator compared with Comparative Example 1.

### Examples 7 to 12

Rechargeable lithium ion battery cells according to Examples 7 to 12 were manufactured according to the same method as Example 1, with the following additions and exceptions.

Herein, Example 7 to 12 formed a coating layer including Al₂O₃ instead of Mg(OH)₂ as an inorganic filler on both sides of the separator compared with Examples 1 to 6.

### Examples 13 to 16 and Comparative Example 3

Rechargeable lithium ion battery cells according to Examples 13 to 16 and Comparative Example 3 were manufactured according to the same method as Example 1, with the following additions and exceptions.

Herein, Example 13 used a lithium nickel composite oxide having a composition of LiNi_{0.83}Co_{0.15}Al_{0.02}O₂ instead of the LiNi_{0.8}Co_{0.15}Al_{0.05}O₂ in Example 2.

In addition, Examples 14 to 16 coated the compound including oxyacid ions on the lithium nickel composite oxide in respectively different amounts from that of Example 13.

On the other hand, the amounts of the compound including oxyacid ions are provided in Table 4.

In addition, Comparative Example 3 used the lithium nickel composite oxide without coating the compound including oxyacid ions compared with Example 13 and simultaneously, formed no coating layer including an inorganic filler on the separator.

### Examples 17 to 22 and Comparative Example 4

Rechargeable lithium ion battery cells according to Examples 17 to 22 were manufactured according to the same method as Examples 1 to 6, with the following additions and exceptions.

Herein, Examples 17 to 22 used a lithium nickel composite oxide having a composition of LiNi_{0.8}Co_{0.15}Mn_{0.05}O₂ instead of the LiNi_{0.8}Co_{0.15}Al_{0.05}O₂ in Examples 1 to 6.

On the other hand, the coated compounds including oxyacid ions are provided in Table 5.

### Reference Example

A rechargeable lithium ion battery cell according to Reference Example was manufactured according to the same method as Comparative Example 1.

Herein, Reference Example used a lithium nickel composite oxide having a composition of LiNi_{0.5}Co_{0.2}Mn_{0.3}O₂ instead of the LiNi_{0.8}Co_{0.15}Al_{0.05}O₂ in Comparative Example 1.

### Evaluation Examples

### High Temperature Storage Test

A high temperature storage test of the rechargeable lithium ion battery cells according to Examples 1 to 22, Comparative Examples 1 to 4, and Reference Example was performed.

Specifically, the rechargeable lithium ion battery cells were charged and discharged at a charge and discharge rate and a cut-off voltage provided in Table 2 and stored at a high temperature of 85° C. for 40 hours, and then, their discharge capacity after storage at the high temperature was measured.

TABLE 2

| | | | Cut-off voltage |
|---|---|---|---|
| Test cycle | Charge rate | Discharge rate | [V] |
| 1 | 0.1 C CC-CV | 0.1 C CC | 4.2-2.5 |
| 2 | 0.2 C CC-CV | 0.2 C CC | 4.2-2.5 |
| Before storage at high | 0.2 C CC-CV | — | 4.2 |
| temperature | | | |
| After storage at high | 0.2 C CC-CV | 0.2 C CC | 4.2-2.5 |
| temperature | | | |

In Table 2, the CC-CV indicates a constant current constant voltage charge, and the CC indicates a constant current discharge.

The cut-off voltage indicates a voltage when a charge ends and a voltage when a discharge ends.

Specifically, the rechargeable lithium ion battery cells were constant current/constant voltage charged at 0.1 C until their voltage reached to 4.2 V in the 1^{st} cycle and constant current discharged at 0.1 C until their voltage reached to 2.5 V.

In addition, in the 2^{nd} cycle, the rechargeable lithium ion battery cells were constant current/constant voltage charged until their voltage reached to 4.2 V and constant current discharged at 0.2 C until their voltage reached to 2.5 V.

On other hand, discharge capacity of the rechargeable lithium ion battery cells in the 2^{nd} cycle was defined as their discharge capacity.

In addition, discharge capacity of the rechargeable lithium ion battery cells according to Example 3, Comparative Example 3 and Reference Example was measured at every charge and discharge rate (C-rate).

Then, the rechargeable lithium ion battery cells were constant current/constant voltage charged at 0.2 C until their voltage reached to 4.2 V and then, stored at a high temperature of 85° C. for 40 hours.

In addition, after the storage at the high temperature, the rechargeable lithium ion battery cells were constant current/constant voltage charged at 0.2 C until their voltage reached to 4.2 V and constant current discharged at 0.2 C until their voltage reached to 2.5 V.

Furthermore, a gas generation amount was measured using the Archimedes method after the storage at high temperature. Additionally, a value per discharge capacity of the positive electrode was obtained by dividing the gas generation amount by the discharge capacity.

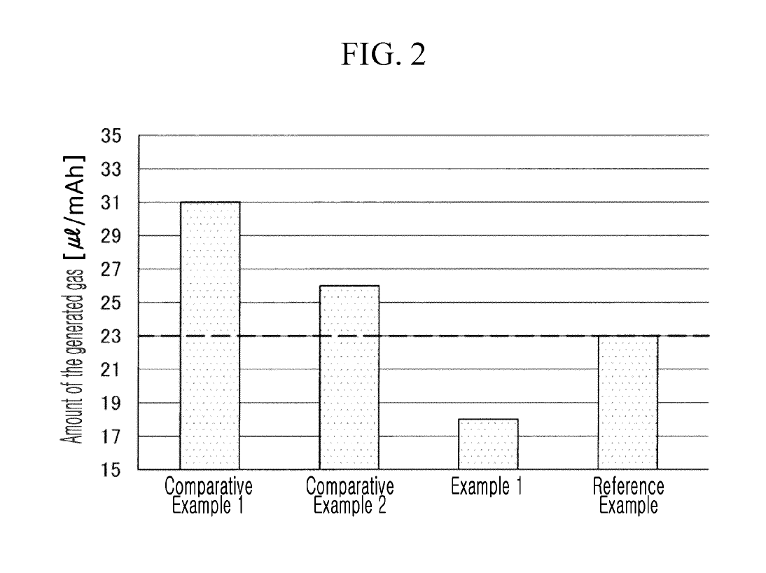

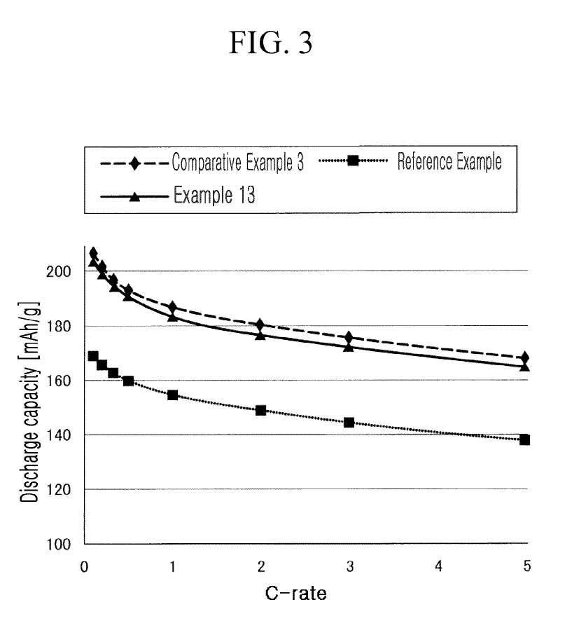

The high temperature storage test results are provided in Tables 3 to 5 and FIGS. 2 and 3.

Table 3 and FIG. 2 show high temperature storage test result of the rechargeable lithium ion battery cell using LiNi_{0.8}Co_{0.15}Al_{0.05}O₂ as a positive active material.

In addition, FIG. 3 shows battery characteristics of the rechargeable lithium ion battery cells according to the present exemplary embodiment, Comparative Example and Reference Example.

In addition, Table 4 shows the results obtained by changing the amount of the compound including oxyacid ions in a rechargeable lithium ion battery cell using LiNi_{0.83}Co_{0.15}Al_{0.02}O₂ as a positive active material.

In addition, Table 5 shows the results of the rechargeable lithium ion battery cells using LiNi_{0.8}Co_{0.15}Mn_{0.05}O₂ as a positive active material.

On the other hand, in Tables 3 to 5, “−” indicates rechargeable lithium ion battery cells using a positive active material not coated with the compound including oxyacid ions, or not having a coating layer, or the like.

First of all, Table 3 and FIG. 2 show high temperature storage test and battery characteristics results of rechargeable lithium ion battery cells using a positive active material of LiNi_{0.8}Co_{0.15}Al_{0.05}O₂.

On the other hand, FIG. 2 is a histogram graph respectively showing the gas generation amounts of Example 1, Comparative Examples 1 and 2, and Reference Example in Table 3.

TABLE 3

| | | Average | | | | Gas |
|---|---|---|---|---|---|---|
| | Composition formula | particle | | Composition | Discharge | generation |
| | of Composite oxide | diameter | Coating | formula of | capacity | amount |
| | particle | [μm] | material | inorganic filler | [mAh/g] | [μl/mAh] |
| Example 1 | LiNi_{0.8}Co_{0.15}Al_{0.05}O₂ | 7 | ammonium | Mg(OH)₂ | 196 | 18 |
| | | | molybdate | | | |
| Example 2 | LiNi_{0.8}Co_{0.15}Al_{0.05}O₂ | 7 | silicotungstic acid | Mg(OH)₂ | 192 | 15 |
| Example 3 | LiNi_{0.8}Co_{0.15}Al_{0.05}O₂ | 7 | phosphomolybdic | Mg(OH)₂ | 193 | 19 |
| | | | acid | | | |
| Example 4 | LiNi_{0.8}Co_{0.15}Al_{0.05}O₂ | 7 | ammonium | Mg(OH)₂ | 195 | 15 |
| | | | phosphotungstate | | | |
| Example 5 | LiNi_{0.8}Co_{0.15}Al_{0.05}O₂ | 7 | ammonium | Mg(OH)₂ | 196 | 12 |
| | | | phosphomolybdate | | | |
| Example 6 | LiNi_{0.8}Co_{0.15}Al_{0.05}O₂ | 7 | ammonium | Mg(OH)₂ | 196 | 15 |
| | | | metavanadate | | | |
| Example 7 | LiNi_{0.8}Co_{0.15}Al_{0.05}O₂ | 7 | ammonium | Al₂O₃ | 196 | 19 |
| | | | molybdate | | | |
| Example 8 | LiNi_{0.8}Co_{0.15}Al_{0.05}O₂ | 7 | silicotungstic acid | Al₂O₃ | 192 | 21 |
| Example 9 | LiNi_{0.8}Co_{0.15}Al_{0.05}O₂ | 7 | phosphomolybdic | Al₂O₃ | 193 | 20 |
| | | | acid | | | |
| Example 10 | LiNi_{0.8}Co_{0.15}Al_{0.05}O₂ | 7 | ammonium | Al₂O₃ | 195 | 16 |
| | | | phosphotungstate | | | |
| Example 11 | LiNi_{0.8}Co_{0.15}Al_{0.05}O₂ | 7 | ammonium | Al₂O₃ | 196 | 13 |
| | | | phosphomolybdate | | | |
| Example 12 | LiNi_{0.8}Co_{0.15}Al_{0.05}O₂ | 7 | ammonium | Al₂O₃ | 196 | 16 |
| | | | metavanadate | | | |
| Comparative | LiNi_{0.8}Co_{0.15}Al_{0.05}O₂ | 7 | | Mg(OH)₂ | 196 | 26 |
| Example 1 | | | | | | |
| Comparative | LiNi_{0.8}Co_{0.15}Al_{0.05}O₂ | 7 | | — | 196 | 31 |
| Example 2 | | | | | | |
| Reference | LiNi_{0.5}Co_{0.2}Mn_{0.3}O₂ | 7 | | Mg(OH)₂ | 165 | 23 |
| Example | | | | | | |

Referring to Table 3, Examples 1 to 12 showed largely suppressed gas generation amounts compared with Comparative Examples 1 and 2.

In addition, Examples 1 to 12 showed similar discharge capacity to those of Comparative Examples 1 and 2 and thus, showed suppression of gas generation without degenerating battery characteristics.

In addition, comparing Examples 1 to 6 with Examples 7 to 12, a cell using either one of Mg(OH)₂ and Al₂O₃ as an inorganic filler turned out to suppress gas generation during the storage at a high temperature.

Referring to FIG. 2, Example 1, Comparative Examples 1 and 2, and Reference Example are illustrated.

Reference Example provides a rechargeable lithium ion battery cell using LiNi_{0.5}Co_{0.2}Mn_{0.3}O₂ of a lithium nickel composite oxide having a low Ni ratio and showing a small gas generation amount.

In contrast Comparative Examples 1 and 2 showed a large gas generation amount during the storage at a high temperature.

On the other hand, although Example 1 using LiNi_{0.8}Co_{0.15}Al_{0.05}O₂ having a large gas generation amount as a lithium nickel composite oxide, a positive electrode according to Example 1 showed a suppressed gas generation amount compared with Reference Example, as the cell according to Example 1 includes a first coating layer including oxyacid ions and a second coating layer including an inorganic filler formed on either one side of a separator.

In particular, referring to FIG. 2, Example 1 showed smaller gas generation amount compared to the Reference Example demonstrating the effect of forming the coating layer including an inorganic filler on either one side of a separator and a positive electrode (Comparative Example 1 vs. Comparative Example 2) and an effect of forming the coating layer including oxyacid ions (Example 1 vs. Comparative Example 2).

Additionally, referring to FIG. 3, battery characteristics of the rechargeable lithium ion battery cells according to the present exemplary embodiment are illustrated.

FIG. 3 is a graph showing discharge capacity at each C-rate of Example 13, Comparative Example 3 and Reference Example.

Referring to FIG. 3, the rechargeable lithium ion battery cell of Example 13 showed almost similar discharge capacity at each C-rate to that of Comparative Example 3.

In addition, Example 13 showed improved discharge capacity compared with Reference Example using LiNi_{0.5}Co_{0.2}Mn_{0.3}O₂ having a very small gas generation amount.

Accordingly, the rechargeable lithium ion battery cells according to the present exemplary embodiment turned out to suppress a gas generation amount but maintain battery characteristics compared with each Comparative Example.

In addition, the rechargeable lithium ion battery cells according to the present exemplary embodiment turned out to suppress a gas generation where the amount is less than or equal to that of Reference Example using a positive active material having a small gas generation amount while maintaining or improving discharge capacity.

Referring to FIG. 3, the rechargeable lithium ion battery cell of Example 13 according to the present exemplary embodiment showed almost equivalent discharge capacity at each C-rate compared with that of Comparative Example 3.

In addition, Example 13 showed improved discharge capacity compared with Reference Example using LiNi_{0.5}Co_{0.2}Mn_{0.3}O₂ having a small gas generation amount.

Therefore, the rechargeable lithium ion battery cells according to the present exemplary embodiment suppressed a gas generation amount but still maintained battery characteristics compared with Comparative Example.

In addition, the rechargeable lithium ion battery cells according to the present exemplary embodiment turned out to improve discharge capacity and suppress a gas generation where the amount is less than or equal to that of Reference Example using a positive active material having a small gas generation amount.

TABLE 4

| | | Average | | | | | Gas |
|---|---|---|---|---|---|---|---|
| | Composition formula | particle | | Amount of | Composition | Discharge | generation |
| | of composite oxide | diameter | Coating | coating | formula of | capacity | amount |
| | particle | [μm] | material | material | inorganic filler | [mAh/g] | [μl/mAh] |
| Example 13 | LiNi_{0.83}Co_{0.15}Al_{0.02}O₂ | 7 | silicotungstic | 0.25 part by | Mg(OH)₂ | 206 | 20 |
| | | | acid | weight | | | |
| Example 14 | LiNi_{0.83}Co_{0.15}Al_{0.02}O₂ | 7 | silicotungstic | 0.5 part by | Mg(OH)₂ | 206 | 18 |
| | | | acid | weight | | | |
| Example 15 | LiNi_{0.83}Co_{0.15}Al_{0.02}O₂ | 7 | silicotungstic | 1 part by | Mg(OH)₂ | 203 | 15 |
| | | | acid | weight | | | |
| Example 16 | LiNi_{0.83}Co_{0.15}Al_{0.02}O₂ | 7 | silicotungstic | 2 part by | Mg(OH)₂ | 199 | 10 |
| | | | acid | weight | | | |
| Comparative | LiNi_{0.83}Co_{0.15}Al_{0.02}O₂ | 7 | | | — | 207 | 40 |
| Example 3 | | | | | | | |

Referring to Table 4, Examples 13 to 16 all showed a suppressed gas generation amount compared with Comparative Example 3.

In addition, Examples 13 to 16 had similar discharge capacity to that of Comparative Example 3 and thus, did not deteriorate battery characteristics such as discharge capacity and the like but was suppressed from gas generation.

Accordingly, when the compound including oxyacid ions in an amount of greater than or equal to about 0.25 part by weight and less than or equal to about 2 part by weight based on 100 part by weight of the total weight of a lithium nickel composite oxide before the coating, a coating layer is formed within the coating ratio according to one embodiment and thus, may suppress gas generation but maintain battery characteristics.

Next, Table 5 shows high temperature storage test and battery characteristics results of Examples 17 to 22 and Comparative Example 4 using LiNi_{0.8}Co_{0.15}Mn_{0.05}O₂ as the lithium nickel composite oxide.

TABLE 5

| | | Average | | | | Gas |
|---|---|---|---|---|---|---|
| | Composition formula | particle | | Composition | Discharge | generation |
| | of composite | diameter | Coating | formula of | capacity | amount |
| | oxide particle | [μm] | material | inorganic filler | [mAh/g] | [μl/mAh] |
| Example 17 | LiNi_{0.8}Co_{0.15}Al_{0.05}O₂ | 7 | ammonium | Mg(OH)₂ | 204 | 16 |
| | | | molybdate | | | |
| Example 18 | LiNi_{0.8}Co_{0.15}Al_{0.05}O₂ | 7 | silicotungstic acid | Mg(OH)₂ | 200 | 13 |
| Example 19 | LiNi_{0.8}Co_{0.15}Al_{0.05}O₂ | 7 | phosphomolybdic | Mg(OH)₂ | 201 | 17 |
| | | | acid | | | |
| Example 20 | LiNi_{0.8}Co_{0.15}Al_{0.05}O₂ | 7 | ammonium | Mg(OH)₂ | 203 | 13 |
| | | | phosphotungstate | | | |
| Example 21 | LiNi_{0.8}Co_{0.15}Al_{0.05}O₂ | 7 | ammonium | Mg(OH)₂ | 204 | 10 |
| | | | phosphomolybdate | | | |
| Example 22 | LiNi_{0.8}Co_{0.15}Al_{0.05}O₂ | 7 | ammonium | Mg(OH)₂ | 204 | 13 |
| | | | metavanadate | | | |
| Comparative | LiNi_{0.8}Co_{0.15}Al_{0.05}O₂ | 7 | | — | 204 | 30 |
| Example 4 | | | | | | |

Referring to Table 5, Example 17 to 22 showed suppression of gas generation amount compared with Comparative Example 4.

In addition, Examples 17 to 22 had equivalent discharge capacity to that of Comparative Example 4 and thus, demonstrated suppression of gas generation without deteriorating battery characteristics such as discharge capacity and the like.

Accordingly, referring to the high temperature storage test and battery characteristic results in Tables 3 to 5, a rechargeable lithium ion battery cell according to one embodiment may be equally suppressed from gas generation about any composition of a lithium nickel composite oxide having a high Ni ratio.

### Evaluation of Coating Coverage Rate

Hereinafter, a coating coverage ratio of a coating layer formed on the surface of the lithium nickel composite oxide particles in Examples 1, 2, 13, 14, and 16 was evaluated.

Specifically, the lithium nickel composite oxide particles after forming the coating layer were examined through SEM and EDX (Energy Dispersive X-ray spectroscopy), and a coating coverage ratio of the coating layer was obtained from the XPS measurement.

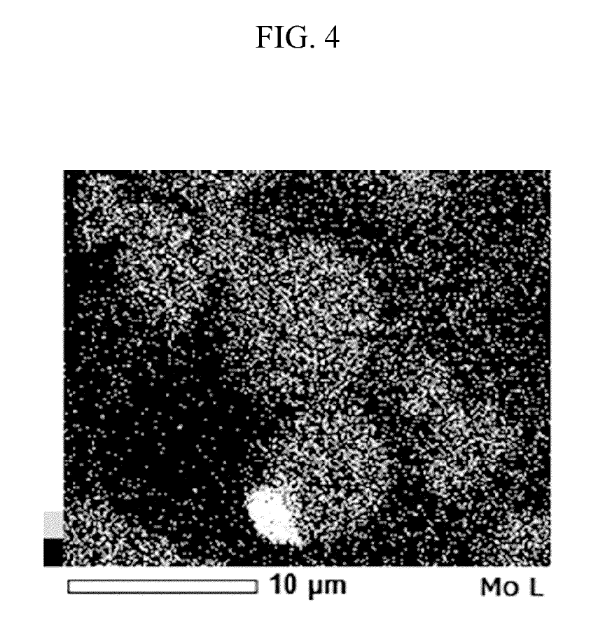

First of all, FIGS. 4, 5, 6 and 7 show EDX results of the lithium nickel composite oxides in Examples 1 and 2.

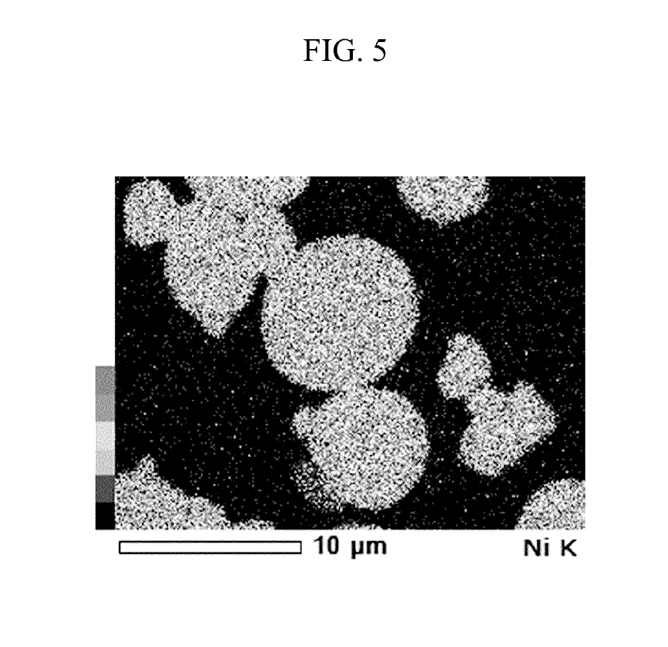

Herein, FIG. 4 shows an EDX phase for Mo of the lithium nickel composite oxide particles according to Example 1, and FIG. 5 shows an EDX phase for Ni of the lithium nickel composite oxide particle according to Example 1.

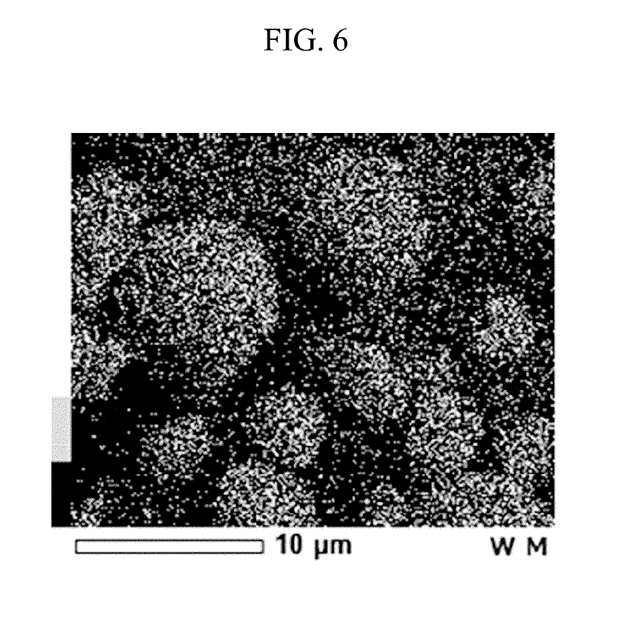

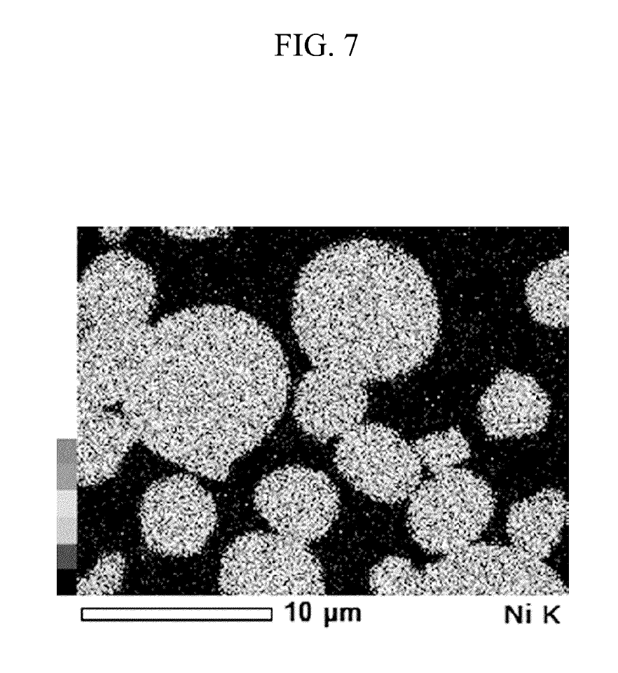

FIG. 6 shows an EDX phase for W of the lithium nickel composite oxide particles according to Example 2, and FIG. 7 shows an EDX phase for Ni of the lithium nickel composite oxide particles according to Example 2.

Furthermore, in FIG. 4, the Mo included in the ammonium molybdate is marked white, and in FIG. 5, the Ni included in the lithium nickel composite oxide is marked white.

Referring to FIGS. 4 and 5, the region where the Mo is present corresponds to the region where the Ni is present, and thus, the ammonium molybdate turned out to be uniformly distributed on the surface of the lithium nickel composite oxide.

In addition, in FIG. 6, W included in silicotungstic acid is marked white, and in FIG. 7, Ni included in a lithium nickel composite oxide is marked white.

Referring to FIGS. 6 and 7, the region where the W is present corresponds with the region where the Ni is present, and thus, the silicotungstic acid turned out to be uniformly distributed on the surface of the lithium nickel composite oxide.

In addition, the XPS of the lithium nickel composite oxide particles of Examples 1, 2, 13, 14, and 16 was measured and revised by reduction of a background, area of a peak, identification of the peaks, and a sensitivity factor to calculate a ratio of the number of atoms of each element as described above.

In addition, the ratio of the number of atoms of each element was used to evaluate a coating coverage ratio of a coating layer on a lithium nickel composite oxide particle.

The evaluation results are provided in Table 6.

TABLE 6

| | | Average | | | | | Gas |
|---|---|---|---|---|---|---|---|
| | Composition formula | particle | | Amount | | Discharge | generation |
| | of composite oxide | diameter | Coating | of coating | Coating | capacity | amount |
| | particle | [μm] | material | material | ratio | [mAh/g] | [μl/mAh] |
| Example | LiNi_{0.8}Co_{0.15}Al_{0.05}O₂ | 7 | ammonium | 1 part by | 5.2 | 196 | 18 |
| 1 | | | molybdate | weight | | | |
| Example | LiNi_{0.83}Co_{0.15}Al_{0.02}O₂ | 7 | silicotungstic | 1 part by | 10.5 | 192 | 15 |
| 2 | | | acid | weight | | | |
| Example | LiNi_{0.83}Co_{0.15}Al_{0.02}O₂ | 7 | silicotungstic | 0.25 part by | 3.9 | 206 | 20 |
| 13 | | | acid | weight | | | |
| Example | LiNi_{0.83}Co_{0.15}Al_{0.02}O₂ | 7 | silicotungstic | 0.5 part by | 8.8 | 205 | 18 |
| 14 | | | acid | weight | | | |
| Example | LiNi_{0.83}Co_{0.15}Al_{0.02}O₂ | 7 | | 1 part by | 17.9 | 199 | 10 |
| 16 | | | | weight | | | |

Referring to Table 6, a coating coverage ratio of a coating layer on a lithium nickel composite oxide according to one embodiment may be in a range of greater than or equal to 1% to less than or equal to 20%.

For Examples 1, 2, 13, 14, and 16 having a coating coverage ratio within the range was suppressed from gas generation.

In addition, Examples 1, 2, 13, 14, and 16 having a coating coverage ratio within the range had equivalent discharge capacity to those of Comparative Examples 1 to 4 and thus, demonstrated suppression of gas generation without deteriorating battery characteristics such as discharge capacity and the like.

As shown in the above results, a rechargeable lithium ion battery cell according to one embodiment may show suppressed gas generation when the cell in a full-charge is stored at a high temperature by using a positive electrode including lithium nickel composite oxide particles having a coating layer including oxyacid ions and a separator and forming a coating layer including an inorganic filler on either one side of the separator and the positive electrode.

In addition, the rechargeable lithium ion battery cell according to one embodiment may use a lithium nickel composite oxide having a high Ni ratio as a positive active material.

In the present disclosure, the terms “Example” and “Comparative Example” are used arbitrarily to simply identify a particular example or experimentation and should not be interpreted as admission of prior art. While this disclosure has been described in connection with what is presently considered to be practical exemplary embodiments, it is to be understood that the invention is not limited to the disclosed embodiments and is intended to cover various modifications and equivalent arrangements included within the spirit and scope of the appended claims.

What is claimed is:

1. A positive electrode for a rechargeable lithium ion battery comprising
a current collector, and
a lithium nickel composite oxide represented by the following Chemical Formula 1, and
a first coating layer positioned on the surface of the lithium nickel composite oxide and including at least one oxyacid ion represented by one of the following Chemical Formulae 2 to 6:
LiₐNi_{b}Co_{c}M_{d}O₂ Chemical Formula 1
[Xⁿ⁺Mo₁₂O₄₀]⁽⁸⁻ⁿ⁾⁻ Chemical Formula 2
[Xⁿ⁺W₁₂O₄₀]⁽⁸⁻ⁿ⁾⁻ Chemical Formula 3
[Xⁿ⁺V₁₂O₄₀]⁽⁸⁻ⁿ⁾⁻ Chemical Formula 4
[Mo₇O₂₄]⁶⁻ Chemical Formula 5
[VO₃]ₘ^{m-} Chemical Formula 6
wherein,
M is selected from Al, Mn, Cr, Fe, V, Mg, Ti, Zr, Nb, Mo, W, Cu, Zn, Ga, In, Sn, La, Ce, or a combination thereof, 0.20≦a≦1.20, 0.80≦b<1.00, 0<c≦0.20, 0≦d≦0.10, and a+b+c=1,
X is P, or Si, n is a natural number of 7 or less, and m is a natural number.

2. The positive electrode for a rechargeable lithium battery of claim 1, wherein a coating coverage ratio of the first coating layer is greater than or equal to about 1% and less than or equal to about 20%.

3. The positive electrode for a rechargeable lithium battery of claim 1, wherein the positive electrode further comprises a second coating layer including an inorganic filler at least one side thereof.

4. The positive electrode for a rechargeable lithium battery of claim 3, wherein the second coating layer comprises Mg(OH)₂ or Al₂O₃.

5. A method of preparing a positive electrode for a rechargeable lithium battery, comprising:
preparing a lithium nickel composite oxide represented by the following Chemical Formula 1;
applying a mechanical shear force to the surface of the lithium nickel composite oxide particle to form a first coating layer including at least one oxyacid ion represented by one of the following Chemical Formulae 2 to 6;
heating the lithium nickel composite oxide particle on which the first coating layer is formed to prepare a positive active material; and
coating the positive active material on a current collector:
LiₐNi_{b}Co_{c}M_{d}O₂ Chemical Formula 1
[Xⁿ⁺Mo₁₂O₄₀]⁽⁸⁻ⁿ⁾⁻ Chemical Formula 2
[Xⁿ⁺W₁₂O₄₀]⁽⁸⁻ⁿ⁾⁻ Chemical Formula 3
[Xⁿ⁺V₁₂O₄₀]⁽⁸⁻ⁿ⁾⁻ Chemical Formula 4
[Mo₇O₂₄]⁶⁻ Chemical Formula 5
[VO₃]ₘ^{m-} Chemical Formula 6
wherein,
M is selected from Al, Mn, Cr, Fe, V, Mg, Ti, Zr, Nb, Mo, W, Cu, Zn, Ga, In, Sn, La, Ce, or a combination thereof, 0.20≦a≦1.20, 0.80≦b<1.00, 0<c≦0.20, 0≦d≦0.10, and a+b+c=1,
X is P, or Si, n is a natural number of 7 or less, and m is a natural number.

6. The method of claim 5, wherein the heating the lithium nickel composite oxide particle on which the first coating layer is formed may be performed under an oxidation atmosphere.

7. The method of claim 5, wherein the coating the positive active material on a current collector is performed at a dew point temperature of about −40° C.

8. A rechargeable lithium battery, comprising
the positive electrode of claim 1;
a negative electrode;
an electrolyte; and
a separator interposed between the positive electrode and the negative electrode.

9. The rechargeable lithium battery of claim 8, wherein the separator comprises a coating layer including an inorganic filler on at least one side thereof.

10. The rechargeable lithium battery of claim 9, wherein the inorganic filler comprises Mg(OH)₂ or Al₂O₃.

11. The rechargeable lithium battery of claim 8, wherein the negative electrode comprises graphite.
